(19) United States
(12) Patent Application Publication
(10) Pub. No.: US 2024/0324145 A1
(43) Pub. Date: Sep. 26, 2024

(54) Heat Pipe Panel for Solar Panel

(71) Applicant: Sunowner Inc., Whippany, NJ (US)

(72) Inventor: Dennis Wilson, Whippany, NJ (US)

(73) Assignee: Sunowner Inc., Whippany, NJ (US)

(21) Appl. No.: 18/680,322

(22) Filed: May 31, 2024

Related U.S. Application Data
(63) Continuation of application No. PCT/US2022/081396, filed on Dec. 12, 2022.
(60) Provisional application No. 63/288,936, filed on Dec. 13, 2021.

(51) Int. Cl. H05K 7/20

(52) U.S. Cl. CPC H05K 7/20336; H05K 7/20327; H05K 7/20454; H05K 7/20936

(57) ABSTRACT

A heat pipe panel comprising a conductive material block defining a plurality of channels or pathways disposed within the material block, fluid disposed within the plurality of channels or pathways, a dry coupling having a conductive outer surface and an interior chamber in fluid communication with the plurality of channels or pathways, a conduit having sockets configured and dimensioned to receive the dry coupling such that heat transfer fluid within the conduit is capable of being heated by conduction from the conductive surface.

### CROSS-REFERENCE TO RELATED APPLICATIONS

This application is a continuation of International Patent Application No. PCT/US2022/081396, filed on Dec. 12, 2022, which claims the benefit of U.S. Provisional Patent Application No. 63/288,936 filed Dec. 13, 2021 entitled “Heat Pipe Panel for Solar Panel”, each of which is incorporated by reference herein in its entirety.

### BRIEF SUMMARY OF THE INVENTION

In one embodiment of the present invention, there is a heat pipe panel comprising a conductive material block defining a plurality of channels or pathways disposed within the material block; fluid disposed within the plurality of channels or pathways, a dry coupling having a conductive outer surface and an interior chamber in fluid communication with the plurality of channels or pathways, a conduit having sockets configured and dimensioned to receive the dry coupling such that heat transfer fluid within the conduit is capable of being heated by conduction from the conductive surface.

In one embodiment, the conductive block comprises: a first plate having a first interior face; and a second plate having a second interior face; the first plate being fixed to the second plate such that the first interior face is proximate the second interior face and the plurality of channels or pathways are defined by the first interior face and second interior face.

In one embodiment, at least one of the first plate and the second plate include at least one depression within at least one of the first interior face and the second interior face, the at least one depression forming the plurality of channels or pathways.

In one embodiment, the plurality of channels (pathways) are substantially parallel and are interconnected at one or both of a first end of the plurality of the channels (pathways) or a second end of the plurality of channels.

In one embodiment, the conductive material block includes an outer surface configured (e.g., coated) to selectively absorb radiation (e.g., infrared radiation) emitted from a solar panel. In some embodiments, the outer surface is configured (e.g., via a coating) to absorb predetermined wavelengths of radiation and to not absorb other wavelengths of radiation. For example, the outer surface may be configured to only absorb infrared radiation. in one embodiment, the outer surface is configured to absorb a high percent of infrared light and a low percentage of visible light. For example, 90% or more of infrared radiation may be absorbed while substantially all visible light is not absorbed. In some embodiments, the outer surface is coated with chromium dioxide to selectively absorb infrared radiation.

In one embodiment, the plurality of channels are under partial vacuum.

In one embodiment, the ratio of surface area of the outer surface to volume of the plurality of channels (or pathways) is sufficient to contain a working fluid in a liquid or a gaseous state.

In one embodiment, the material block comprises two metal sheets welded together about a perimeter of the material block to form an airtight aperture between the metal sheets, the airtight aperture comprising the plurality of channels or pathways.

In one embodiment, the condensing bulb comprises a bulb formed from material having conductive properties that are substantially similar to the conductive properties of the material block.

In one embodiment, the plurality of channels are configured in a continuous pattern.

In one embodiment, further comprising a plurality of partitions configured to form the plurality of channels or pathways from the lower end of the panel to the upper end of the panel containing the tube leading to the condensing bulb

In one embodiment, the means for forming a metal to metal heat transfer can be enhanced by a heat transfer paste in the socket at time of insertion

In one embodiment, the heat gathered by the heat pipe panel is transferred to the working fluid in the heat pipe panel causing the working fluid to vaporize into a gas.

In one embodiment, the liquid in the lower portion of the heat pipe panel gathers heat from the surroundings of the heat pipe panel converting the working fluid to a gas, and that gas flows upward in the heat pipe panel gathering additional heat energy as it flows to the top of the heat pipe panel; and due to the higher specific weight of the working fluid as a liquid, some of that liquid remains in the lower portion of the heat pipe panel.

In one embodiment, the gas formed from the vaporization of the working fluid gathers additional heat energy as it flows up between the metal surfaces of the heat pipe panel and is drawn to the tube entrance by the condensing action of the bulb forming a relatively lower vacuum, which is surrounded by the cooler temperature of the socket which is in turn cooled by the circulating fluid in the manifold.

In one embodiment, the gas flows upward collecting additional heat until it is draw into the tube connected to the bulb portion of the extension from the upper side of the heat pipe panel where it then condenses into droplets of working fluid on the inner surface of the bulb which droplets then flow down the tube and into the major inner space of the heat pipe panel.

In one embodiment, the working gas is condensed back into a liquid form which then flows down the inner surface of the heat pipe panel to the lower portion of the panel where it rejoins the liquid working fluid to repeat the cycle as long as heat is gathered into the panel by conduction, radiation and convection to power the cycle of boiling the working fluid into gas then condensing the gas back into liquid working fluid.

In one embodiment, the heat pipe panel is comprised of two sheets of metal formed into an airtight chamber, the metal sheets are of a thickness and a strength such that the chamber contains the working fluid as a liquid and as a gas with no leaks or distortion that significantly changes the volume of the interior space of the heat pipe panel.

In one embodiment, the formation of the metal sheets to form the chamber is such that the metal sheets forming the chamber remain rigid with little or no distortion or flexing that would cause metal fatigue during the working life of the heat pipe panel, which is expected to be at least thirty years.

In one embodiment, the metal sheets forming the heat pipe panel are selected and manufactured so that the panel contains the partial vacuum necessary for the liquid to vapor cycle through the expected operating temperature and pressure range experienced by the heat pipe panel, considering both the extremes of ambient temperatures experienced in place behind a solar electric module and the maximum temperatures experienced under continuous direct sun under stagnation conditions.

In one embodiment, the material from which the surfaces of the heat pipe panel are manufactured to meet durability standards such that the heat pipe panel will experience no metal fatigue or apparatus damage from extended stagnation periods, where stagnation occurs when there is no circulation of fluid in the manifold to remove the heat impinging on the heat pipe panel under continuous direct sun on the solar electric module under which the heat pipe panel is placed.

In one embodiment, the insulation placed between the rear surface of the heat pipe panel and the exterior in contact with the outside atmosphere shall be of a thickness and resistance to heat transfer as is desired for the efficiency of heat retention for the climatic conditions of different geographic regions in which the heat pipe panel will be located.

In one embodiment, the heat pipe panel consists of a chamber formed by the joining of two sheets of metal forming an airtight chamber by joining the sheets at the perimeter edge including a metal tube attached to a condensing bulb, all connected with their interiors to form a continuous space sealed from the outside atmosphere.

In one embodiment, during the manufacture of the heat pipe panel and prior to its final assembly to seal the interior space a measured amount of working fluid is injected into the interior and a sufficient amount of air is evacuated from the interior to leave the interior of the heat pipe panel with a designated level of vacuum appropriate to the operation of the heat pipe panel.

In one embodiment, the amount of working fluid introduced into the interior is calculated to achieve the correct amount working fluid, in liquid and gaseous form, to power the passive operation of the heat pipe panel in transferring heat from the heat pipe panel into the manifold as the working fluid within the heat pipe panel absorbs heat from its surroundings, converts working fluid from liquid to gas, moves that gas over the interior surfaces of the heat pipe panel to absorb additional heat energy, then move that gas into the condensing bulb to transfer its heat into the manifold.

In one embodiment, the relative vacuum pressure imparted to the interior of the heat pipe panel upon manufacture is calculated to achieve the desired boiling point of the working fluid necessary to drive the heat pipe cycle from liquid to gas and back to liquid within the temperatures that the heat pipe panel will encounter when placed behind and in close proximity with the rear surface of the most commonly found solar electric modules currently in place on residential and commercial roofs or currently being sold in the marketplace.

### BRIEF DESCRIPTION OF THE DRAWINGS

The invention will be more clearly understood from the following description given by way of example only, with reference to the accompanying drawings in which:

FIG. 1 is a perspective view of a heat pipe panel, in accordance with at least one embodiment of the present invention.

FIG. 2 is a sectional view through the heat pipe panel of the heat pipe panel of FIG. 1, showing the depressions in each metal sheet, which connect in the middle of the heat pipe panel chamber and the condensing bulb for connection to a heat pipe connector, in accordance with at least one embodiment of the present invention.

FIG. 3 is a cross section of a heat pipe connector showing the hollow socket, the space to hold a working fluid surrounding the socket, the integral tube to carry the working fluid to the condensing bulb which will be inserted into a manifold, and the insulation covering the heat pipe connector with the exception of the condensing bulb and the socket opening in accordance with at least one embodiment of the present invention.

FIG. 4 is an exploded view of the heat pipe panel arrangement, located behind a solar electric module and surrounded by the frame of the solar electric module, the attached condensing bulb to be inserted into the heat pipe connector or manifold, and the heat pipe connector with its receiving socket, in one embodiment with an insulating panel 13 placed behind the heat pipe panel in accordance with at least one embodiment of the present invention.

### DETAILED DESCRIPTION

The present invention relates to a heat pipe panel for gathering of heat from its surroundings when placed behind a solar electric module and in close proximity to the rear surface of the solar module so that heat energy conducted, radiated or converted to the heat pipe panel may transfer the heat gathered through the action of vaporization of a working fluid within the heat pipe panel to a condensing chamber wherein the gas condenses back into the working fluid and in so doing delivers the heat gathered into a manifold to be used for heating water or into a space heating system.

The solar electric module in which the heat pipe panel is typically mounted may be on a pitched residential roof in either a portrait or landscape orientation, or on racking tilted in a southerly direction off horizontal, so that one edge of the frame of the solar module is higher than the main body of the solar electric module and is bolted with fastening hardware to rails that are permanently attached to roof members or other structural components of the roof. The solar electric module typically has an aluminum frame of various dimensions, generally of at least one inch in height and less than three inches in height, which when fastened to the structural rails places the front surface of the solar electric module approximately four to six inches above the plane of the roof surface. The rail supporting the weight of the solar module is typically about two inches in height and may be raised above the plane of the roof one to two inches, thus leaving a space of five to six inches from the plane of the roof surface to the rear plane of the solar electric module. The heat pipe panel, while of a dimension covering most of the surface area of the rear of the solar electric module, may be constructed of thin metal sheets sealed to form an airtight chamber containing a working fluid filling a minority of the space within the panel. The heat pipe panel may be attached to the frame of the solar collector, and may be manufactured of lightweight metal, adding little weight to the solar electric modules on the roof.

The solar electric module may produce electric current when exposed to sunlight and a portion of the energy in that sunlight, generally less than 25%, may be converted to electric energy by generating movement of electrons within the silicon, or other photovoltaic material within the solar electric module. The balance of the sunlight energy that cannot be converted into the movement of electrons within the module may be absorbed as heat energy, which raises the temperature of the solar electric module relative to its surroundings. This heat energy may be radiated to the sky or to the surroundings in the vicinity of the solar electric module. Due to the smaller distance from the rear of the solar module to the roof surface than from the front of the solar electric module, the rear surface of the solar electric module can become hotter than the front surface of the module. The temperature rise of the solar electric module may vary and depend on the intensity of sunlight, the radiant emission characteristics of the particular solar electric module, the ambient temperature of the surroundings and the speed of any wind on the surfaces of the solar module. When a solar module has been sitting under full sun the temperature of the solar module may often climb to as much as 50 degrees above the ambient air temperature surrounding the solar module. This temperature rise may vary with the presence or absence of clouds, the angle of the sunlight received relative to the plane of the solar module and other ambient conditions acting on the solar module.

The sunlight converted to heat by the solar electric module may be captured and put to use by the heat pipe panel through the vaporization of the working fluid in the heat pipe panel, the gathering of additional heat energy as the working fluid as a gas flows over the interior surface of the heat pipe panel and delivers the heat gathered by the condensing of the gas in the condensing bulb within the manifold. The heated fluid circulating through the manifold may carry the heat gathered by the heat pipe panel to heat water in storage for domestic use, thus displacing the use of fossil energy, or providing that heat to a space heating system or other system to displace a portion of the fossil energy or other energy otherwise consumed.

The temperature rise of the solar module and the photovoltaic material contained within the module affects the electric generation characteristics of the solar module such that the voltage produced declines as the temperature of the photovoltaic material increases. This inverse relationship to increasing temperature reduces the instantaneous efficiency of converting sunlight to electric current and can reduce generation as much as 10% compared to operation at ambient temperature. Conversely, reducing the temperature of the solar electric module increases the instantaneous electric output of the solar electric module.

In many cases the heat pipe panel may be used with optional insulation material in the form of a rigid insulating board placed to the rear of the heat pipe panel. The insulating board may prevent some of the heat gathered by the heat pipe panel from escaping from the rear of the heat pipe panel and increase the percentage of the heat energy collected into the manifold. In some hotter than average climates it may be preferable to dispense with the use of insulating material to allow some heat to dissipate off the rear of the heat pipe panel to limit temperature rise of the solar electric module.

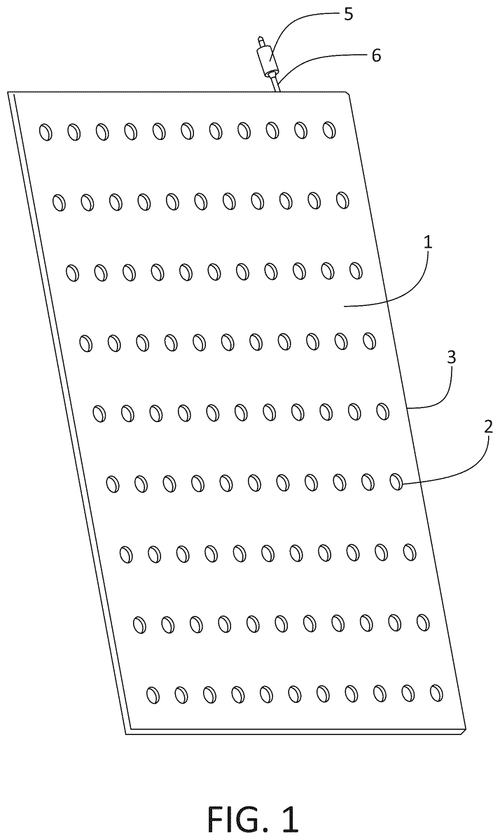

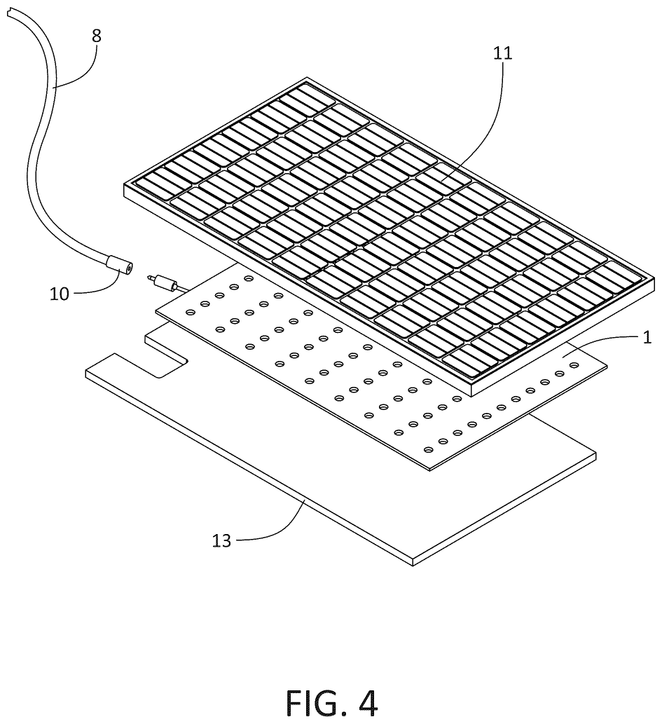

Referring to the drawings in detail, wherein like reference numerals indicate like elements throughout, there is shown in FIGS. 1-4 a heat pipe panel, generally designated, in accordance with an exemplary embodiment of the present invention.

As illustrated in FIG. 1, a chamber may be comprised of two sheets of metal joined together at the perimeter 3 to form an airtight space in which a working fluid fills a minority of the space 4 with the interior of the airtight space connected to a metal tube extending from the interior space, and ending in a metal bulb 5 in a tubular shape whose interior space is a continuous space with the space between the two sheets of metal that each have a pattern of depressions and are joined in the interior by welds joining the depressions 2 to create a separation between the metal sheets and are sealed together at the perimeter to form an airtight space combined with the tube 6 and metal bulb shape condensing chamber 5. In one embodiment, the two metal sheets are joined together through the process of welding, brazing, soldering or other mechanical joining.

The metal interior space 4 may be under a partial vacuum, which may lower the boiling point of the working fluid compared to its boiling point under atmospheric pressure at sea level. The relative vacuum within the heat pipe panel chamber and condensing bulb may vary from a state of rest when the temperature of the heat pipe panel is lower than the boiling point of the working fluid under partial vacuum and no heat is being transferred into the heat pipe panel and the manifold surrounding the condensing bulb is at that same temperature.

Being under a partial vacuum the working fluid may boil when heat from the area and surfaces surrounding the heat pipe panel chamber receive heat energy, and that heat energy is sufficient to power the phase change of the working fluid from a liquid to a gas 7. That gas may then flow upward from the lower portion of the panel toward the upper end, filling the interior space of the heat pipe panel. Because the upper end of the panel may be elevated from the horizontal, the gas may continue to fill the interior until it occupies the interior space of the panel until the gas may enter the tube 6 leading to the condensing chamber and may fill the condensing chamber with warmed gas 5 where it may encounter the interior surface of the condensing bulb 5 and may warm that surface which may then warm the surface of the metal socket in contact with the exterior of the condensing bulb. As the gas in the heat pipe panel may continue to increase in temperature more working fluid may convert to gas increasing the relative pressure in the panel and may push more gas toward the upper portion of the panel. As the gas flows upward in the panel it absorbs more heat energy further increasing the pressure of the gas. In one embodiment, as more warmed gas flows into the condensing bulb the interior surface of the condensing bulb 5 continues to climb in temperature until it reaches a point where it transfers sufficient heat to the metal surface of the socket surrounding the condensing bulb to condense the working fluid gas back into droplets of liquid working fluid. The action of condensing of the gas in the condensing bulb may transfer heat into the manifold containing the condensing bulb sockets. That heat transfer may warm the interior of the manifold until the temperature sensor attached to the manifold piping signals the differential controller to close an electrical circuit to send electricity to the circulating pump to start circulation of the glycol fluid or water from the heat exchanger in the storage vessel to the manifold and back to the heat exchanger. In one embodiment, as long as the temperature sensor continues to measure a lower temperature in the heat exchanger at the storage vessel than at the manifold containing the condensing bulb of the panel, the heat pipe panel will continue to transfer heat gathered from the heat pipe panel into the condensing bulb due to the cooling effect of the glycol flowing around the socket in a manifold into which the condensing bulb 5 is inserted into a socket 10. In one embodiment, as long as the heat pipe panel continues to collect heat from its surroundings and convert liquid working fluid to a gaseous form, the condensing action of the working fluid as a gas back into liquid state and the transfer of the heat gathered from the heat pipe panel 1 through the metal wall of the condensing bulb 5 to the metal wall of the receiving socket 10 in the manifold or heat pipe connector, and the passing of the heat through that wall to the glycol fluid circulating though the manifold to a remote storage vessel containing water or other liquid storage medium will continue.

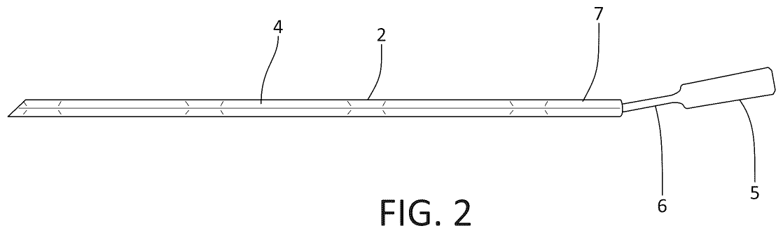

FIG. 2 shows a cross section view of the heat pipe panel 1 showing the space between the points of contact 2 between the front metal surface and the rear metal surface forming the heat pipe panel enclosure, which points of attachment may serve to permanently bond the two metal surfaces and in doing so may make the panel more rigid and able to withstand varying pressures, both negative and positive, that occur as the temperatures and pressures in the heat pipe panel 1 vary due to the effect those temperatures and pressures may have on the working fluid within the heat pipe panel.

The tube extending from the interior of the heat pipe panel 6 to the condensing bulb 5 can be of various lengths but is of sufficient length for the condensing bulb 5 to insert snugly into its respective receiving port in the manifold or into the receiving port of a heat pipe connector.

Once the bulb 5 is inserted into its respective socket 10 in the manifold or the heat pipe connector the metal to metal snug fit may enable the efficient transfer of heat from the condensing bulb 5 to the receiving metal socket in the manifold whenever the condensing bulb 5 is at a higher temperature than the metal of the receiving port.

The tight friction fit of the outer surface of the condensing bulb 5 to the metal of the receiving port may enable the heat transfer from one metal surface to the surrounding metal surface of the receiving port, of which heat is then transferred by the metal skin of the receiving port to the liquid flowing though the manifold, and thence flowing to the heat exchanger contained within the storage tank. The tube connected to the interior of the heat pipe panel and thence to the condensing bulb may be of metal construction sufficient in diameter 6 to carry the working fluid as a gas to the condensing bulb 5 and the return of the droplets of working fluid as the gas condenses.

The liquid working fluid droplets may then be returned by the action of gravity or by capillary action to the lower portion of the heat pipe panel 1 where those droplets of working fluid join the liquid working fluid in the lower end of the heat pipe panel 1 to be reheated by the absorption of heat by the heat pipe panel from its surroundings. In one embodiment, the tube 6 connecting to the condensing bulb 5 shall be made of flexible metal material sufficient in strength to contain the negative partial vacuum of the heat pipe panel as it encounters varying temperatures and pressures but have sufficient flexibility so as to allow the easy alignment of the rigid condensing bulb 5 into the rigid metal receiving port of the manifold or the extension tube socket.

The manifold shell surrounding the interior of the manifold may be made of a material resistant to weather and shall be constructed of weather resistant metal or plastic designed to be exposed to the exterior weather conditions and temperatures experienced on flat or pitched roofs anywhere in the world and may not deteriorate from such conditions for a minimum period of 25 years. The shell may be constructed of multiple pieces joined together to form a weather tight enclosure around the piping within the manifold and the insulation material surrounding the piping within the outer shell of the manifold. The manifold may have numerous receiving ports so that multiple condensing bulbs 5 connected to multiple heat pipe panels or multiple heat pipe connectors may be inserted into adjacent receiving ports in a single manifold device located at a higher elevation of the heat pipe panel.

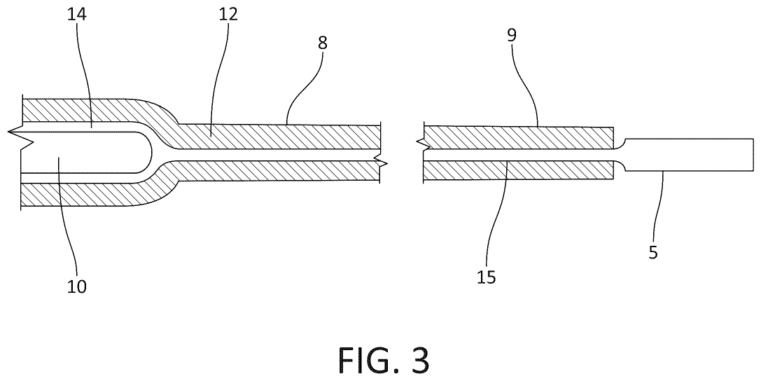

FIG. 3 is a cross section of one embodiment of a heat pipe connector showing the hollow socket, the space to carry a working fluid surrounding the socket, the integral tube to carry the working fluid proximate the condensing bulb when the condensing bult is inserted into the socket in a closely fit configuration. Also illustrated in FIG. 3 is insulation covering the heat pipe connector as illustrated by cross-hatching. In one embodiment, the heat pipe connector 8 is designed to operate as an extension of the condensing bulb 5 of a heat pipe panel and to transfer the heat received in its evaporator socket 10 to the end with a condensing chamber 5, and is constructed to have two ends connected by a hollow metal tube 15 with the interior space in the hollow metal tube 15 and structures at each end under a partial vacuum containing a working fluid sufficient to transfer the heat energy received to the other end with the condensing bulb 5.

The upper end of the heat pipe connector 8 may have a tubular condensing bulb 5 attached and the lower end may be attached to a hollow evaporator socket 10 manufactured to receive a condensing bulb 5 attached to and a part of a heat pipe panel 1.

In one embodiment, the socket end is a metal-lined evaporator socket 10 having a hollow space 14 radially disposed about socket 10 that is configured to hold working fluid and may be connected to the interior space of the tube 15 and sufficient in amount to efficiently transfer the heat energy received in the socket from the condensing bulb of a nearby heat pipe panel 5.

The double walled socket end 10 may be designed and dimensioned to receive a bulb 5 in a dry connection and transfer heat from the exterior surface of the condensing bulb 5 to the exterior surface of the socket surrounding the condensing bulb inserted in the socket 10, thence through the inner wall of the socket to the working fluid contained in the space between the two walls of the evaporator socket and tube 8, which space may be under a partial vacuum, which vacuum may be of sufficient negative pressure as to lower the boiling point of the working fluid to the desired temperature range.

In some embodiments, the hollow metal tube 15 is an insulated tube that extends into a forked tube such that there is formed a circumferentially oriented hollow wall 12 that is in fluid communication with the hollow metal tube 15. The circumferential hollow wall 12 is configured to receive, by a friction fit, a condensing bulb 5.

In one embodiment, as the heat is transferred to the working fluid surrounding the socket 10 the liquid working fluid is converted into a gaseous state, and that gas then travels up the interior of the tube 15 to the upper end of the heat pipe connector where it enters a condensing bulb 5 and is converted back to droplets of working fluid as it transfers its heat energy of condensation to the metal skin of the receiving socket in a manifold.

The interior space surrounding the inner wall of the receiving socket 10 may contain working fluid under a partial vacuum and may be contiguous with the interior space of the tube 15 that connects to the condensing bulb 5 at the upper end of the connector.

In one embodiment, the condensing bulb 5 at the upper end of the connector will be inserted into a socket in a manifold where it will transfer its heat to the manifold containing water or glycol surrounding the socket 10, which heat is then then circulated to storage. The operation of the working fluid converting to gas will continue as long as the heat transferred to the socket 10 at the lower end of the heat pipe connector 8 is in sufficient amount to drive the vaporization cycle of the working fluid.

The condensing of the gas in the condensing bulb 5 back into droplets of working fluid may continue for as long as the socket surrounding the condensing bulb 5 is at a lower temperature sufficient to absorb the heat of condensation of the working fluid as a gas.

In one embodiment, the outer surface of the receiving socket 10 and the tube up to the condensing bulb 5 are covered by a layer of insulation 12 sufficient in thickness to reduce the transmittance of heat from the tube 15 and the outer surface of the socket 10 of the connector to acceptable levels for the effective operation of the heat pipe connector to operate to transfer the heat received in the socket 10 to the condensing bulb 5 end of the connector.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. The words “right”, “left”, “lower” and “upper” designate directions in the drawings to which reference is made. The words “inwardly” and “outwardly” refer to directions toward and away from, respectively, the geometric center of the DEVICE. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A heat pipe panel comprising:
a conductive material block defining a plurality of channels or pathways disposed within the material block;
fluid disposed within the plurality of channels or pathways;
a dry coupling having an a conductive outer surface and an interior chamber in fluid communication with the plurality of channels or pathways;
a conduit having sockets configured and dimensioned to receive the dry coupling such that heat transfer fluid within the conduit is capable of being heated by conduction from the conductive surface.

2. The heat pipe panel of claim 1, wherein the conductive block comprises:
a first plate having a first interior face; and
a second plate having a second interior face;
the first plate being fixed to the second plate such that the first interior face is proximate the second interior face and the plurality of channels or pathways are defined by the first interior face and second interior face.

3. The heat pipe panel of claim 2, wherein at least one of the first plate and the second plate include at least one depression within at least one of the first interior face and the second interior face, the at least one depression forming the plurality of channels or pathways.

4. The heat pipe panel of claim 1, wherein the plurality of channels or pathways are substantially parallel and are interconnected at one or both of a first end of the plurality of the channels or pathways or a second end of the plurality of channels.

5. The heat pipe panel of claim 1, wherein the conductive material block includes an outer surface configured to conduct heat being emitted from a solar electric module.

6. The heat pipe panel of claim 1, wherein the plurality of channels are under partial vacuum.

7. The heat pipe panel of claim 5, wherein the ratio of surface area of the outer surface to volume of the plurality of channels or pathways is sufficient to contain a working fluid in a liquid or a gaseous state.

8. The heat pipe panel of claim 1, wherein the material block comprises two metal sheets welded together about a perimeter of the material block to form an airtight aperture between the metal sheets, the airtight aperture comprising the plurality of channels or pathways.

9. The heat pipe panel of claim 1, wherein the dry socket comprises a bulb formed from material having conductive properties that are substantially similar to the conductive properties of the material block.

10. The heat pipe panel of claim 1, wherein the plurality of channels are configured in a continuous pattern.

11. The heat pipe panel of claim 1 further comprising a plurality of partitions configured to form the plurality of channels or pathways from the lower end of the panel to the upper end of the panel containing the tube leading to the condensing bulb.

12. The heat pipe panel of claim 2, wherein the means for forming a metal-to-metal heat transfer can be enhanced by a heat transfer paste applied to the socket at time of insertion.

13. The apparatus in claim 1, wherein the heat gathered by the heat pipe panel is transferred to the working fluid in the heat pipe panel causing the working fluid to vaporize into a gas.

14. The heat pipe panel of claim 1, where the liquid in the lower portion of the heat pipe panel gathers heat from the surroundings of the heat pipe panel converting the working fluid to a gas, and that gas flows upward in the heat pipe panel gathering additional heat energy as it flows to the top of the heat pipe panel; and due to the higher specific weight of the working fluid as a liquid, that liquid remains in the lower portion of the heat pipe panel.

15. The heat pipe panel of claim 1, wherein the gas formed from the vaporization of the working fluid gathers additional heat energy as it flows up between the metal surfaces of the heat pipe panel and is drawn to the tube entrance by the condensing action of the bulb forming a relatively lower vacuum, which is surrounded by the cooler temperature of the socket which is in turn cooled by the circulating fluid in the manifold.

16. The heat pipe panel of claim 6, wherein the gas flows upward collecting additional heat until it is drawn into the tube connected to the bulb portion of the extension from the upper side of the heat pipe panel where it then condenses into droplets of working fluid on the inner surface of the bulb which droplets then flow down the tube and into the major inner space of the heat pipe panel.

17. The heat pipe panel of claim 6, wherein the working gas is condensed back into a liquid form which then flows down the inner surface of the heat pipe panel to the lower portion of the panel where it rejoins the liquid working fluid to repeat the cycle as long as heat is gathered into the panel by conduction, radiation and convection to power the cycle of boiling the working fluid into gas then condensing the gas back into liquid working fluid.

18. The heat pipe panel of claim 1, wherein the heat pipe panel is comprised of two sheets of metal formed into an airtight chamber, the metal sheets are of a thickness and a strength such that the chamber contains the working fluid as a liquid and as a gas with no leaks or distortion that changes the volume of the interior space of the heat pipe panel.

19. The heat pipe panel of claim 9, the formation of the metal sheets to form the chamber is such that the metal sheets forming the chamber remain rigid with no distortion or flexing that would cause metal fatigue during the working life of the heat pipe panel, which is expected to be at least thirty years.

20. The heat pipe panel of claim 10, wherein the metal sheets forming the heat pipe panel are selected and manufactured so that the panel contains the partial vacuum necessary for the liquid to vapor cycle through the expected operating temperature and pressure range experienced by the heat pipe panel, considering both the extremes of ambient temperatures experienced in place behind a solar electric module and the maximum temperatures experienced under continuous direct sun under stagnation conditions.

21. The heat pipe panel of claim 11, wherein the material from which the surfaces of the heat pipe panel are manufactured to meet durability standards such that the heat pipe panel will experience no metal fatigue or apparatus damage from extended stagnation periods, where stagnation occurs when there is no circulation of fluid in the manifold to remove the heat impinging on the heat pipe panel under continuous direct sun on the solar electric module under which the heat pipe panel is placed.

22. The heat pipe panel of claim 1, wherein insulation placed between the rear surface of the heat pipe panel and the exterior in contact with outside atmosphere shall be of a thickness and resistance to heat transfer desired for the efficiency of heat retention for the climatic conditions of different geographic regions in which the heat pipe panel will be located.
